(19) United States
(12) Patent Application Publication
(10) Pub. No.: US 2022/0268516 A1
(43) Pub. Date: Aug. 25, 2022

(54) COOLING AND/OR LIQUEFYING SYSTEM AND METHOD

(71) Applicant: L'Air Liquide, Societe Anonyme pour l'Etude et l'Exploitation des Procedes Georges Claude, Paris (FR)

(72) Inventors: Fabien DURAND, Sassenage (FR); Remi NICOLAS, Sassenage (FR); Cecile GONDRAND, Sassenage (FR); Jean-Marc BERNHARDT, Sassenage (FR)

(73) Assignee: L'Air Liquide, Societe Anonyme pour l'Etude et l'Exploitation des Procedes Georges Claude, Paris (FR)

(21) Appl. No.: 17/632,992

(22) PCT Filed: Jul. 8, 2020
(86) PCT No.: PCT/EP2020/069187

§ 371 Date: Feb. 4, 2022

(30) Foreign Application Priority Data
Aug. 5, 2019 (FR) FR 1908946

(51) Int. Cl. F25J 1/00

(52) U.S. Cl. CPC F25J 1/0022; F25J 1/005; F25J 1/0284

(57) ABSTRACT

Disclosed is a low-temperature refrigeration device comprising a working circuit that forms a loop and contains a working fluid, the device further comprising a cooling exchanger for extracting heat from at least one member by exchanging heat with the working fluid, the working circuit forming a cycle comprising, connected in series: a compression mechanism, a cooling mechanism, an expansion mechanism and a heating mechanism, wherein the mechanism for cooling the working fluid and the heating mechanism comprise a common heat exchanger in which the working fluid flows in opposite directions in two separate transit portions of the circuit according to whether it is cooled or heated, the device being designed to ensure equal mass flow rates in the two transit portions in the common heat exchanger, the device also comprising a bypass for bypassing one of the two transit portions, said bypass comprising a bypass valve which, in the open state, changes the mass flow rate in one of the two transit portions.

### CROSS-REFERENCE TO RELATED APPLICATIONS

This application is a § 371 of International PCT Application PCT/EP2020/069187, filed Jul. 8, 2020, which claims § 119(a) foreign priority to French patent application FR 1908946, filed Aug. 5, 2019.

### BACKGROUND

### Field of the Invention

The invention relates to a refrigeration device and to a cooling and/or liquefaction system and method using such a device.

The invention relates more particularly to a low-temperature refrigeration device, that is to say for refrigeration at a temperature of between minus 100 degrees centigrade and minus 273 degrees centigrade, in particular between minus 100 degrees centigrade and minus 253 degrees centigrade, comprising a working circuit forming a loop and containing a working fluid, the device comprising a cooling exchanger intended to extract heat at at least one member by heat exchange with the working fluid circulating in the working circuit, the working circuit forming a cycle comprising, in series: a mechanism for compressing the working fluid, a mechanism for cooling the working fluid, a mechanism for expanding the working fluid, and a mechanism for heating the working fluid, wherein the mechanism for cooling the working fluid and the heating mechanism comprise a common heat exchanger through which the working fluid passes in countercurrent in two separate passage portions of the circuit depending on whether it is cooled or heated, the device being configured to ensure an equal mass flow rate in said two passage portions in the common heat exchanger.

The invention relates in particular to cryogenic refrigerators or liquefiers, for example of the type having a “Turbo Brayton” cycle or “Turbo Brayton coolers” in which a cycle gas (helium, nitrogen or another pure gas or a mixture) undergoes a thermodynamic cycle producing cold which can be transferred to a member or a gas intended to be cooled.

### Related Art

These devices are used in a wide variety of applications and in particular for cooling natural gas in a tank (for example in ships). The liquefied natural gas is for example subcooled to avoid vaporization thereof or the gaseous part is cooled in order to be reliquefied.

For example, a flow of natural gas can be made to circulate in a heat exchanger cooled by the cycle gas of the refrigerator/liquefier.

The gas cooled in this exchanger may contain impurities, which are likely to solidify at the cold temperatures achieved at the exchanger. This can block the heat exchanger and impair the efficiency of the system.

One solution may consist in actively heating the heat exchanger with an electric heater. This is costly in terms of energy, however, and often unsuitable for explosive atmospheres.

### SUMMARY OF THE INVENTION

An aim of the present invention is to overcome all or some of the drawbacks of the prior art that are set out above.

To this end, the device according to the invention, which is otherwise in accordance with the generic definition thereof given in the above preamble, is essentially characterized in that the device comprises a bypass duct bypassing one of the two passage portions, said bypass duct comprising a bypass valve which, when it is open, modifies the mass flow rate in one of the two passage portions.

Furthermore, embodiments of the invention may include one or more of the following features:
the open bypass valve modifies the mass flow rate in one of the two passage portions to ensure a different mass flow rate in said two passage portions so as to ensure a given amount of heating or less cooling at the cooling exchanger compared with when the device is operating with identical mass flow rates in the two portions,
the bypass duct and the bypass valve are configured to reduce the mass flow rate of working fluid provided for the passage portion in question by a given quantity,
the bypass duct and the bypass valve are configured to reduce the mass flow rate provided for the passage portion in question by 2% to 30% and preferably by 5% to 15%,
the device has a bypass duct forming a bypass of the passage portion provided for heating the working fluid in the common heat exchanger, said bypass duct comprising an upstream end connected to the working circuit upstream of the common heat exchanger and a downstream end connected to the circuit downstream of the common heat exchanger,
the upstream end of the bypass duct is connected to the working circuit downstream of the expansion mechanism, between the expansion mechanism and the common heat exchanger, or upstream of the expansion mechanism, between the common heat exchanger and the expansion mechanism,
the downstream end of the bypass duct is connected to the circuit between the common heat exchanger and the compression mechanism or within the compression mechanism,
the device has a bypass duct forming a bypass of the passage portion provided for cooling the working fluid in the common heat exchanger, said bypass duct comprising an upstream end connected to the working circuit upstream of the common heat exchanger and a downstream end connected to the circuit downstream of the common heat exchanger,
the upstream end of the bypass duct is connected to the working circuit between the compression mechanism and the common heat exchanger or within the compression mechanism,
the downstream end of the bypass duct is connected to the working circuit between the common heat exchanger and the expansion mechanism or between the expansion mechanism and the common heat exchanger,
the device comprises an electronic controller connected to the bypass valve, the electronic controller being configured to control the opening of the bypass valve to ensure the increase in temperature of the common heat exchanger according to a given profile and/or to limit the speed of the increase in temperature of the common heat exchanger to below a given threshold,
the device comprises a sensor for measuring a representative temperature of the common heat exchanger, the electronic controller being configured to control the opening of the bypass valve depending on the measurement taken by the sensor for measuring a representative temperature of the exchanger,
the compression mechanism comprises one or more compressors and at least one drive motor for rotating the compressor(s), the refrigeration capacity of the device being variable and controlled by regulating the speed of rotation of the drive motor(s), the electronic controller being configured to reduce the refrigeration capacity of the device when the bypass valve is open,
the bypass valve is a gradually opening valve and/or an all or nothing valve allowing a given calibrated flow rate or one associated with a given flow rate restriction member.

The invention also relates to a system for cooling and/or liquefying a flow of fluid, in particular natural gas, comprising a refrigeration device according to any one of the features above or below, the system comprising a circulation duct for said flow of fluid to be cooled in heat exchange with the cooling exchanger of the refrigeration device, wherein the refrigeration device is configured to cool the cooling exchanger in order to cool the fluid that is circulating in the duct when the bypass valve is closed, and to heat the cooling exchanger in order to evacuate any impurities that have solidified in said cooling exchanger.

The invention also relates to a method for cooling and/or liquefying a flow of fluid, in particular natural gas, using such a system, the method including a step of cooling the cooling exchanger in order to cool the fluid circulating in the duct via the operation of the refrigeration device without opening the bypass valve, the method comprising a step of defrosting and evacuating impurities that have solidified in said cooling exchanger during the cooling step, the step of defrosting and evacuating impurities comprising heating the cooling exchanger via operation of the refrigeration device with the bypass valve in an open position.

The invention may also relate to any alternative device or method comprising any combination of the features above or below within the scope of the claims.

### BRIEF DESCRIPTION OF THE FIGURES

Further particular features and advantages will become apparent upon reading the following description, which is given with reference to the figures, in which:

FIG. 1 shows a schematic and partial view illustrating the structure and operation of an example of a system that can implement the invention,

FIG. 2 shows a schematic and partial view illustrating the structure and operation of a possible exemplary embodiment of a refrigeration and/or liquefaction device according to the invention.

### DETAILED DESCRIPTION OF THE INVENTION

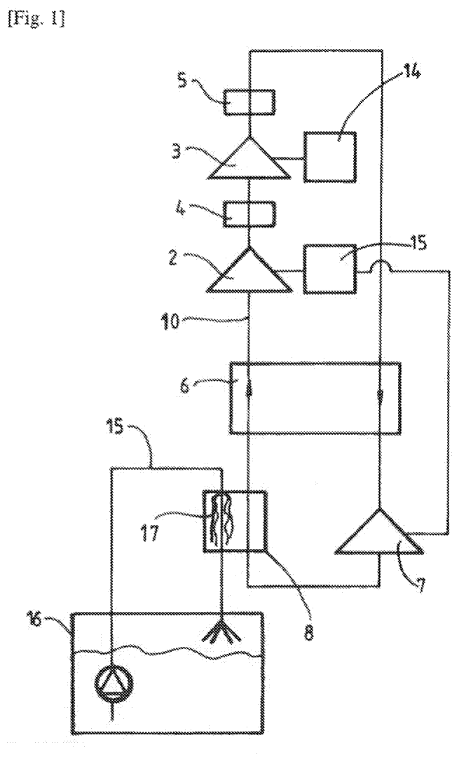

The cooling and/or liquefaction system in [FIG. 1] comprises a refrigeration device 1 that supplies cold (a cooling capacity) at a cooling exchanger 8. The system comprises a duct 25 for circulation of a flow of fluid to be cooled placed in heat exchange with this cooling exchanger 8. For example, the fluid is liquid natural gas pumped from a tank 16, then cooled (preferably outside the tank 16), then returned to the tank 16 (for example raining down in the gas phase of the tank 16). This makes it possible to cool or subcool the contents and to limit the occurrence of vaporization. For example, the liquid from the tank 16 is subcooled below its saturation temperature (drop in its temperature of several K, in particular 5 to 20K and in particular 14K) before being reinjected into the tank 16. In a variant, this refrigeration can be applied to the vaporization gas from the tank in order in particular to reliquefy it.

The low-temperature refrigeration device comprises a working circuit 10 (preferably closed) forming a circulation loop. This working circuit 10 contains a working fluid (helium, nitrogen, neon, hydrogen or another appropriate gas or mixture, for example helium and argon or helium and nitrogen or helium and neon or helium and nitrogen and neon).

The working circuit 10 forms a cycle comprising, in series: a mechanism 2, 3 for compressing the working fluid, a mechanism 6 for cooling the working fluid, a mechanism 7 for expanding the working fluid, and a mechanism 6, 8 for heating the working fluid.

The device 1 comprises a cooling heat exchanger 8 intended to extract heat at at least one member 25 by heat exchange with the working fluid circulating in the working circuit 10.

The mechanisms for cooling and heating the working fluid conventionally comprise a common heat exchanger 6 through which the working fluid passes in countercurrent in two separate passage portions of the working circuit depending on whether it is cooled or heated.

The cooling heat exchanger 8 is situated for example between the expansion mechanism 7 and the common heat exchanger 6. As illustrated, the cooling heat exchanger 8 may be a heat exchanger separate from the common heat exchanger 6.

However, in a variant, this cooling heat exchanger 8 could be made up of a portion of the common heat exchanger 6 (meaning that the two exchangers 6, 8 can be in one piece, i.e. may have separate fluid circuits that share one and the same exchange structure).

Thus, the working fluid which leaves the compression mechanism 2, 3 in a relatively hot state is cooled in the common heat exchanger 6 before entering the expansion mechanism 7. The working fluid which leaves the compression mechanism 7 and the heat exchanger 8, for exchanging heat with the fluid to be cooled, in a relatively cold state is, for its part, cooled in the common heat exchanger 6 before returning into the compression mechanism 2, 3 in order to start a new cycle.

Conventionally, in a normal operating mode (the working gas undergoes the cycle of compression, cooling, expansion and heating and produces cold at the cooling exchanger 8), an equal mass flow rate circulates in the two passage portions in the common heat exchanger 6 (an equal mass flow rate means an equal or substantially equal flow rate, i.e. one that does not differ by more than a few percent). This circulation is schematically indicated by arrows in the schematic depictions and the terms “upstream” and “downstream” that are used in the description refer to the direction of circulation of the working fluid in the circuit.

The device comprises a bypass duct 9 bypassing one of the two passage portions, said bypass duct 9 being provided with a bypass valve 11. When it is open, this bypass valve 11 creates a thermodynamic imbalance in the working circuit, which results in production of heat and therefore a given amount of heating at a cooling exchanger 8.

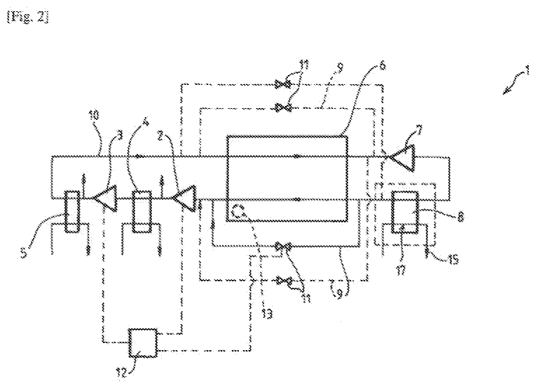

Thus, as illustrated in [FIG. 2], if in the normal operating mode, a flow of fluid (liquefied natural gas) can be cooled in the cooling exchanger 8. In the event that this fluid contains impurities (carbon dioxide or the like) that are likely to solidify as they are cooled, a blockage 17 or an obstruction may arise in the cooling exchanger 8.

By temporarily opening the bypass valve 11, the exchanger 8 can thus be sufficiently heated to sublimate or liquefy these impurities which are then easy to evacuate. Preferably, during this defrosting heating, the flow of fluid to be cooled can be interrupted (or reduced).

The normal operating mode (cooling) can be resumed by closing the bypass valve 11.

For example, the bypass valve 11 is configured to reduce the mass flow rate provided for the passage portion in question by 2% to 30% and preferably by 5% to 15%. For example, the bypass valve 11 is a gradually opening valve and/or an all or nothing valve designed to allow a given calibrated flow rate or a valve associated with a given flow rate restriction member.

As shown using solid lines in [FIG. 2], the bypass duct 9 may form a bypass of the passage portion provided for heating the working fluid in the common heat exchanger 6 (that is to say the portion of the common heat exchanger that heats the fluid leaving the compression mechanism 2, 3 before it arrives in the expansion mechanism 7). Thus, the bypass duct 9 has an upstream end connected to the working circuit 10 upstream of the common heat exchanger 6 and a downstream end connected to the circuit 10 downstream of the common heat exchanger 6. In this example using solid lines, the upstream end of the bypass duct 9 is connected to the working circuit 10 downstream of the expansion mechanism 7 and the cooling exchanger 8, between the cooling exchanger 8 and the inlet of the common heat exchanger 6.

The downstream end of this bypass duct 9 is connected to the working circuit 10 between the common heat exchanger 6 and the inlet of the compression mechanism 2, 3.

Of course, this example is in no way limiting. [FIG. 2] thus illustrates, using dashed lines, other nonlimiting embodiment variants of the bypass duct 9.

For example, the upstream end of the bypass duct 9 may be connected upstream of the expansion mechanism 7, between the common heat exchanger 6 and the expansion mechanism 7 between the outlet of the common heat exchanger 6. The downstream end of the bypass duct 9 may be connected between the common heat exchanger 6 and the compression mechanism 2, 3 (or within the compression mechanism 2, 3, i.e. between two compression stages, for example).

These arrangements have the following advantages: the temperature of the working fluid at the inlet of the compression mechanism 2, 3 is disturbed little, if at all, compared with a normal cycle.

Similarly, in a variant, the bypass duct 9 may be configured to form a bypass of the passage portion provided for cooling the working fluid in the common heat exchanger 6. Thus, the bypass duct 9 may comprise an upstream end connected to the working circuit 10 upstream of the common heat exchanger 6, for example between the outlet of the compression mechanism 2, 3 and the common heat exchanger 6 or within the compression mechanism 2, 3. Similarly, the downstream end of the bypass duct 9 may be connected to the working circuit 10 downstream of the common heat exchanger 6, between the common heat exchanger 6 and the expansion mechanism 7 or downstream of this expansion mechanism 7, for example between the outlet of the cooling heat exchanger 8 and the inlet of the common heat exchanger 6.

These arrangements have the following advantages: the bypass valve 11 is disposed in the hot part of the device (at non-cryogenic temperatures), the flow of working fluid admitted into the bypass duct 9 is at a relatively high pressure (at the outlet of the compression mechanism), this making it possible to use a simple and relatively small valve.

The device may comprise an electronic controller 12 connected to the bypass valve 11. The electronic controller 12 may comprise a microprocessor or a computer and may be configured to dynamically control the opening of the bypass valve 11 to ensure an increase in temperature of the common heat exchanger 6 according to a given profile and/or to limit the speed of the increase in temperature of the common heat exchanger 6 to below a given threshold. This may make it possible to prevent the common heat exchanger 6 and/or the cooling exchanger 8 from heating up too quickly, this being advantageous in the case for example of an exchanger having an aluminum plate.

For this purpose, the device 1 may comprise at least one sensor 13 for measuring a representative temperature of the common heat exchanger 6, transmitting its signal to the electronic controller 12. The electronic controller 12 may be configured to control the opening of the bypass valve 11 (duration and/or section) depending on the measurement by this sensor 3, for example the opening of the valve 11 may depend on this temperature measurement.

The compression mechanism 2, 3 comprises one or more compressors and at least one drive motor 14, 15 for rotating the compressor(s) 2, 3, the refrigeration capacity of the device preferably being variable and controlled by regulating the speed of rotation of the drive motor(s) 14, 15 (cycle speed). Preferably, the cold capacity produced by the device 1 can be adapted by 0 to 100% of a nominal or maximum capacity by changing the speed of rotation of the motor(s). Such an architecture makes it possible to maintain a high performance level over a wide operating range (for example 97% of nominal performance at 50% of the nominal cold capacity).

Although the instantaneous heating (in particular for defrosting) of the cooling exchanger 8 can be realized at a normal cycle speed for a cooling cycle, preferably, the electronic controller 12 (or another dedicated electronic controller) may be configured to reduce the speed of the motor(s) of the device when the bypass valve 11 is open. For example, the motors are slowed to around 1 to 60%, and in particular 20 to 30% of their maximum or nominal speed.

The nominal speed or maximum speed of a motor means the maximum speed that the motor can produce in the case of a maximum refrigeration capacity. This maximum or nominal speed is the maximum speed advised for the operation of the refrigeration device 1 and may, if necessary, be lower than the maximum speed that the motor can intrinsically achieve.

In the examples depicted, the refrigeration device comprises two compressors that form two compression stages and an expansion turbine. This means that the compression mechanism comprises two compressors 2, 3 in series, preferably of the centrifugal type, and the expansion mechanism comprises a single turbine 7, preferably a centripetal turbine. Of course, any other number and arrangement of the compressor(s) and turbine(s) may be envisioned, for example three compressors and one turbine or three compressors and two turbines, or two compressors and two turbines, etc.

In the examples illustrated, a cooling exchanger 4, 5 is provided at the outlet of each compressor (for example cooling with water at ambient temperature or any other cooling agent or fluid). This makes it possible to realize isentropic or isothermal or substantially isothermal compression. Of course, any other arrangement may be envisioned (for example no cooling exchanger 4, 5 having one or more compression stages). Similarly, a heating exchanger may or may not be provided at the outlet of all or part of the expansion turbines 7 to realize isentropic or isothermal expansion. Also preferably, the heating and cooling of the working fluid are preferably isobaric, without this being limiting.

For example, the device 1 comprises two high-speed motors 14, 15 (for example 10 000 revolutions per minute or several tens of thousands of revolutions per minute) for respectively driving the two compression stages 2, 3. The turbine may be coupled to the motor 2 of one of the compression stages 2, 3, meaning that the device may have a turbine 8 forming the expansion mechanism which is coupled to the drive motor 2 of a compression stage 2 (in particular the first).

Thus, the power of the turbine(s) 7 can advantageously be recovered and used to reduce the consumption of the motor(s). Thus, by increasing the speed of the motors (and thus the flow rate in the cycle of the working gas), the refrigeration capacity produced and thus the electrical consumption of the liquefier are increased (and vice versa). The compressors 2, 3 and turbine(s) 7 are preferably coupled directly to an output shaft of the motor in question (without a geared movement transmission mechanism).

The output shafts of the motors are preferably mounted on bearings of the magnetic type or of the dynamic gas type. The bearings are used to support the compressors and the turbines.

Moreover, all or part of the device, in particular the cold members thereof, can be accommodated in a thermally insulated sealed casing (in particular a vacuum chamber containing the cold components: cooling exchanger 8, turbine 7, and optionally the common countercurrent heat exchanger).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context dearly dictates otherwise.

“Comprising” in a claim is an open transitional term which means the subsequently identified claim elements are a nonexclusive listing i.e. anything else may be additionally included and remain within the scope of “comprising,” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A method for cooling and/or liquefying a flow of fluid, comprising the steps of:
providing a low-temperature refrigeration device for refrigeration at a temperature of between minus 100 degrees centigrade and minus 273 degrees centigrade, the refrigeration device comprising:
a working circuit forming a loop and containing a working fluid;
a cooling exchanger intended to extract heat at at least one member by heat exchange with the working fluid circulating in the working circuit, the working circuit forming a cycle comprising, in series: a mechanism for compressing the working fluid, a mechanism for cooling the working fluid, a mechanism for expanding the working fluid, and a mechanism for heating the working fluid, wherein the mechanism for cooling the working fluid and the heating mechanism comprise a common heat exchanger through which the working fluid passes in countercurrent in two separate passage portions of the circuit depending on whether it is cooled or heated, the device being configured to ensure an equal mass flow rate in said two passage portions in the common heat exchanger;
a bypass duct bypassing one of the two passage portions, said bypass duct comprising a bypass valve which, when it is open, modifies the mass flow rate in one of the two passage portions; and
a circulation duct for said flow of fluid to be cooled in heat exchange with the cooling exchanger of the refrigeration device, wherein the refrigeration device is configured to cool the cooling exchanger in order to cool the fluid to be cooled that is circulating in the duct, with the bypass valve closed, and when more than a given quantity of frost is present, to heat the cooling exchanger with the bypass valve open in order to evacuate impurities that have solidified in said cooling exchanger;
cooling the cooling exchanger in order to cool the fluid circulating in the duct via the operation of the refrigeration device without opening the bypass valve; and
defrosting and evacuating impurities that have solidified in said cooling exchanger during the cooling step by heating the cooling exchanger via operation of the refrigeration device with the bypass valve in an open position.

17. The method of claim 16, wherein the open bypass valve modifies the mass flow rate in one of the two passage portions to ensure a different mass flow rate in said two passage portions so as to ensure a given amount of heating or less cooling at the cooling exchanger compared with when the device is operating with identical mass flow rates in the two portions.

18. The method of claim 16, wherein the bypass duct and the bypass valve are configured to reduce the mass flow rate of working fluid provided for the passage portion in question by a given quantity.

19. The method of claim 18, wherein the bypass duct and the bypass valve are configured to reduce a mass flow rate provided for the passage portion in question by 2% to 30%.

20. The method of claim 16, wherein the bypass duct forms a bypass of the passage portion provided for heating the working fluid in the common heat exchanger, said bypass duct comprising an upstream end connected to the working circuit upstream of the common heat exchanger and a downstream end connected to the circuit downstream of the common heat exchanger.

21. The method of claim 19, wherein the upstream end of the bypass duct is connected to the working circuit downstream of the expansion mechanism, between the expansion mechanism and the common heat exchanger, or upstream of the expansion mechanism, between the common heat exchanger and the expansion mechanism.

22. The method of claim 20, wherein the downstream end of the bypass duct is connected to the circuit between the common heat exchanger and the compression mechanism or within the compression mechanism.

23. The method of claim 16, wherein the bypass duct forms a bypass of the passage portion provided for cooling the working fluid in the common heat exchanger, said bypass duct comprising an upstream end connected to the working circuit upstream of the common heat exchanger and a downstream end connected to the circuit downstream of the common heat exchanger.

24. The method of claim 23, wherein the upstream end of the bypass duct is connected to the working circuit between the compression mechanism and the common heat exchanger or within the compression mechanism.

25. The method of claim 23, wherein the downstream end of the bypass duct is connected to the working circuit between the common heat exchanger and the expansion mechanism or between the expansion mechanism and the common heat exchanger.

26. The method of claim 16, further comprising a step of controlling the opening of the bypass valve with an electronic controller connected to the bypass valve to ensure the increase in temperature of the common heat exchanger according to a given profile and/or to limit a speed of an increase in temperature of the common heat exchanger to below a given threshold.

27. The method of claim 26, wherein said refrigeration device further comprises a sensor for measuring a representative temperature of the common heat exchanger and the electronic controller is configured to control the opening of the bypass valve depending on the measurement taken by the sensor.

28. The method of claim 26, wherein the compression mechanism comprises one or more compressors and at least one drive motor for rotating the compressor(s), the refrigeration capacity of the device being variable and controlled by regulating the speed of rotation of the drive motor(s), and the electronic controller is configured to reduce the refrigeration capacity of the device when the bypass valve is open.

29. The method of claim 16, wherein the bypass valve is a gradually opening valve and/or an all or nothing valve allowing a given calibrated flow rate or one associated with a given flow rate restriction member.

30. The method of claim 16, wherein the fluid is natural gas.
